(19) United States
(12) Patent Application Publication
(10) Pub. No.: US 2015/0068504 A1
(43) Pub. Date: Mar. 12, 2015

(54) CONTROL DEVICE FOR EXHAUST GAS RECIRCULATION VALVE

(71) Applicant: Aisan Kogyo Kabushiki Kaisha, Obu-shi (JP)

(72) Inventor: Makoto HATANO, Nagoya-shi (JP)

(21) Appl. No.: 14/335,495

(22) Filed: Jul. 18, 2014

(30) Foreign Application Priority Data
Sep. 6, 2013 (JP) 2013-184867

(51) Int. Cl. F02D 41/00; F02M 25/07

(52) U.S. Cl. CPC F02D 41/0077; F02M 25/0754; F02M 25/0772
USPC 123/568.26

(57) ABSTRACT

An EGR valve includes a valve housing having a gas passage and a motor housing containing a motor. The valve housing and the motor housing are made of different materials. The valve housing is provided with a valve seat, a valve element, and a valve shaft. The motor includes a stator having a coil and a rotor having an output shaft. The output shaft is rotated together with the rotor, thereby making stroke movement of the valve shaft in an axial direction to change an opening degree of the valve element with respect to the valve seat. An ECU for controlling the EGR valve determines a target opening degree of the EGR valve, uses the coil as a temperature sensor to detect the temperature of the motor, compensates a target opening degree based on the detected temperature, and controls the motor based on the compensated target opening degree.

### CROSS-REFERENCE TO RELATED APPLICATIONS

This application is based upon and claims the benefit of priority from the prior Japanese Patent Application No. 2013-184867 filed on Sep. 6, 2013, the entire contents of which are incorporated herein by reference.

### BACKGROUND OF THE INVENTION

1. Field of the Invention

The present invention relates to an exhaust gas recirculation valve of an exhaust gas recirculation apparatus of an engine and, more particularly, to a control device for controlling an exhaust gas recirculation valve.

2. Related Art

As the above type of technique, there is known an exhaust gas recirculation valve (EGR valve) disclosed in for example JP-A-2013-7266. In general, the EGR valve of this kind includes a valve metal housing having a flow passage for EGR gas, and a motor resin housing containing a motor. The valve housing is provided with a valve shaft, a valve element, a valve seat, which are made of metal, and other components. The valve shaft and the valve element are provided to be able to make stroke movement in an axial direction with respect to the valve seat. In the motor housing, there are placed a stator, a rotor, and an output shaft, and others constituting the motor.

### SUMMARY OF INVENTION

### Problems to be Solved by the Invention

However, in the EGR valve disclosed in JP-A-2013-7266, the valve housing and the motor housing are made of different kinds of materials which are different in linear expansion coefficient. This may cause a difference in linear expansion between the valve housing and the motor housing due to temperature change. On a high temperature side, particularly, the linear expansion of the motor housing is apt to be large. Accordingly, a stroke movement amount of the valve shaft may be deviated from a target stroke amount due to the difference in linear expansion with the valve housing. This results in a deviation of an opening degree defined between a valve element and a valve seat from a target opening degree, which may cause a deviation of the flow characteristics of the EGR valve from target characteristics.

Therefore, in order to prevent the deviation of the flow characteristics due to temperature change, it is conceived to provide a temperature sensor in the EGR valve to compensate the opening/closing operation of the EGR valve according to the temperature change. However, if the temperature sensor is provided in the EGR valve, the number of components and the size of the EGR valve are increased by just that much, leading to cost increase.

The present invention has been made in view of the circumstances and has a purpose to provide a control device for an exhaust gas recirculation valve, capable of preventing flow characteristic deviation of the exhaust gas recirculation valve due to temperature change without additionally providing a dedicated temperature sensor.

### Means of Solving the Problems

To achieve the above purpose, one aspect of the invention provide a control device for an exhaust gas recirculation valve, wherein the exhaust gas recirculation valve includes a valve housing having a gas passage and a motor housing containing a motor, the valve housing and the motor housing being made of different kinds of materials, the valve housing is provided with a valve seat, a valve element placed to be movable into or out of contact with the valve seat, and a valve shaft for moving the valve element with respect to the valve seat, the motor includes: a stator having a coil; and a rotor having an output shaft, the motor being configured to rotate the rotor together with the output shaft to make stroke movement of the valve shaft in an axial direction to change an opening degree of the valve element with respect to the valve seat, the control device includes a control unit to control the exhaust gas recirculation valve, and the control unit is configured to determine a target opening degree of the exhaust gas recirculation valve, use the coil as a temperature sensor for detecting a temperature of the motor, compensate the target opening degree based on the detected temperature, and control the motor based on the compensated target opening degree.

### Advantageous Effects of Invention

According to the present invention, it is possible to prevent the flow characteristic deviation of an exhaust gas recirculation valve due to temperature change without additionally providing a dedicated temperature sensor.

### BRIEF DESCRIPTION OF THE DRAWINGS

FIG. 1 is a cross sectional view of an EGR valve in a fully closed state and a schematic diagram of a control device for the EGR valve in an embodiment;

FIG. 2 is a flowchart showing one example of a temperature compensating processing in the embodiment;

FIG. 3 is a flowchart showing one example of processing details of EGR control;

FIG. 4 is a map to be referred to in converting a motor temperature according to a coil resistance value in the embodiment;

FIG. 5 is a map to be used for reference in determining a stroke compensation amount corresponding to a motor temperature in the embodiment; and

FIG. 6 is a graph showing a relationship between stroke (opening degree) of a valve element of an EGR valve and EGR gas flow rate in the embodiment.

### DESCRIPTION OF EMBODIMENTS

A detailed description of a preferred embodiment of a control device for an exhaust gas recirculation (EGR) valve embodying the present invention will now be given referring to the accompanying drawings.

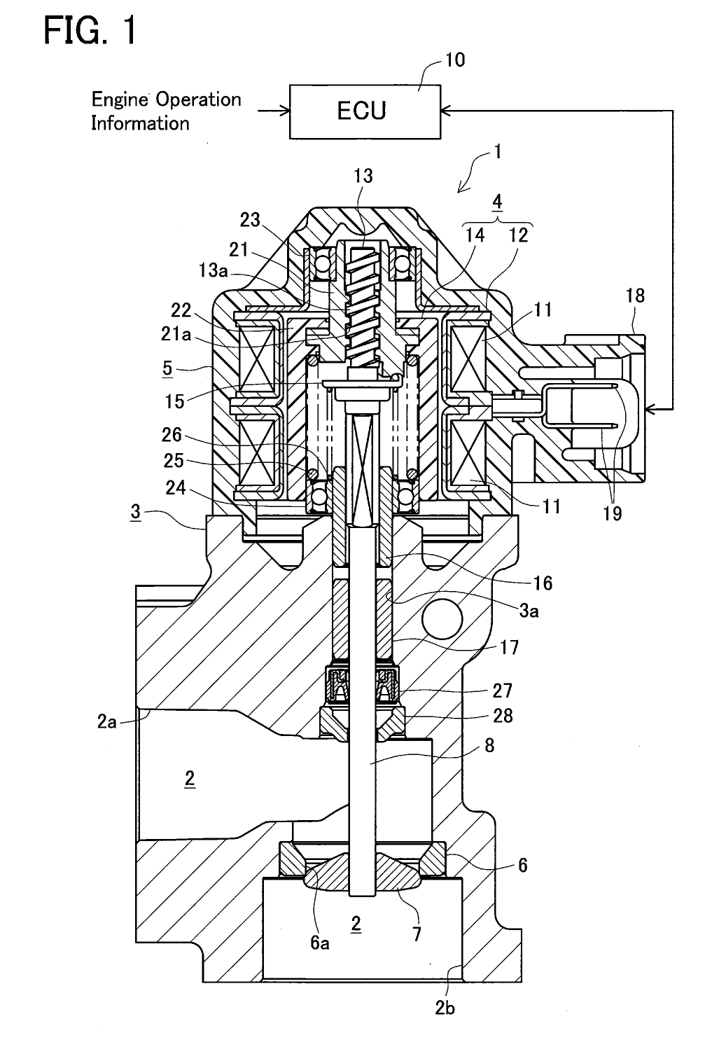

FIG. 1 is a cross sectional view of an EGR valve 1 in a fully closed state and a schematic diagram of a control device for the EGR valve 1. The EGR valve 1 is provided in an EGR passage for allowing part of exhaust gas discharged from an engine to return as EGR gas to an intake passage. The EGR valve 1 is used to regulate an EGR gas flow rate.

The EGR valve 1 includes, as shown in FIG. 1, a valve housing 3 that is made of metal and formed with a gas passage 2, and a motor housing 5 that is made of resin and contains a motor 4. The valve housing 3 is provided with a valve seat 6 placed in the gas passage 2, a valve element 7 placed to be movable into and out of contact with the valve seat 6, and a valve shaft 8 integrally provided with the valve element 7 to move the valve element 7 with respect to the valve seat 6. An EGR gas measuring part is formed between the valve seat 6 and the valve element 7. The motor 14 includes a stator 12 having coils 11 and a rotor 14 having an output shaft 13. This EGR valve 1 is configured to rotate the rotor 14 of the motor 4 together with the output shaft 13, thereby making stroke movement of the valve shaft 8 in the axial direction, to change an opening degree of the valve element 7 with respect to the valve seat 6 to regulate the EGR gas flow rate in the gas passage 2. In the present embodiment, the control device for the EGR valve 1 includes an electronic control unit (ECU) 10 for controlling the motor 4 to control the EGR valve 1. The ECU 10, which corresponds to one example of a control unit of the present invention, is configured to control the EGR valve 1 based on operation information of the engine (various signals representing an operating condition of the engine).

The gas passage 2 is formed to be bent at a right angle in a nearly hook-like shape as a whole in the valve housing 3. Both ends of the gas passage 2 are an inlet 2a through which EGR gas flows in and an outlet 2b through which EGR gas flows out. The valve seat 6 is provided as a separate member from the valve housing 3 and mounted at some point of the gas passage 2.

The valve shaft 8 is provided between the motor 4 and the valve element 7 and placed to extend vertically through the valve housing 3 in FIG. 1. The valve element 7 is provided at a lower end of the valve shaft 8 and has a nearly cone shape to come into or out of contact with the valve seat 6. The valve shaft 8 is integrally provided, at its upper end, with a spring retainer 15. Between the valve housing 3 and the valve shaft 8, there are provided a first thrust bearing 16 and a second thrust bearing 17 arranged in series to support the valve shaft 8 so as to allow stroke movement of the valve shaft 8. Each of the thrust bearings 16 and 17 has a nearly cylindrical shape and is fixedly fitted in a mounting hole 3a formed at the center of the valve housing 3.

In the motor 4, the rotor 14 is placed inside the stator 12, and the output shaft 13 is placed through the center of the rotor 14. Those coils 11, stator 12, output shaft 13, rotor 14, spring retainer 15, and others are covered by a motor housing 5 made of resin. The motor housing 5 is formed integrally with a connector 18 extending sideways, in which terminals 19 extending from the coils 11 are provided.

The output shaft 13 has a male screw 13a on the outer periphery. A lower end of the output shaft 13 is connected to the spring retainer 15 provided at a distal end of the valve shaft 8. The rotor 14 includes a rotor main body 21 and a cylindrical plastic magnet 22 integrally provided on the outer periphery of the rotor main body 21. A first radial bearing 23 is provided between the outer periphery of an upper end portion of the rotor main body 21 and the motor housing 5. A second radial bearing 24 is provided between the inner periphery of a lower end portion of the plastic magnet 22 and the first thrust bearing 16. With the above upper and lower, radial bearings 23 and 24, the rotor 14 is supported rotatably inside the stator 12. The rotor main body 21 is formed, on its internal surface, with a female screw 21a threadedly engaging with the male screw 13a of the output shaft 13. A first compression spring 25 is provided between the rotor 14 and the lower, second radial bearing 24. A second compression spring 26 is provided between the spring retainer 15 and the second radial bearing 24 to bias the valve shaft 8 toward the rotor 14.

Between the valve housing 3 and the valve shaft 8, a nearly-cylindrical lip seal 27 is provided adjacent to the second thrust bearing 17 to seal between the valve housing 3 and the valve shaft 8. A deposit guard plug 28 is provided under the lip seal 27. The lip seal 27 and the deposit guard plug 28 are press-fitted and fixed in the mounting hole 3a. The valve shaft 8 is placed extending through the center the lip seal 27 and the deposit guard plug 28.

In the present embodiment, as shown in FIG. 1, the valve seat 6 includes a valve hole 6a at the center. The valve element 7 is placed inside the valve hole 6a so as to be movable together with the valve shaft 8 in the axial direction of the valve seat 6 between a fully closed position in which the valve element 7 contacts with the inner peripheral surface of the valve hole 6a and a fully open position in which the valve element 7 is most apart from the inner peripheral surface of the valve hole 6a.

In the EGR valve 1 in the present embodiment, the valve housing 3 and the motor housing 5 are made of different materials. Thus, a linear expansion difference occurs between the valve housing 3 and the motor housing 5 due to temperature change, which may cause a deviation of EGR gas flow rate from target flow characteristics. To prevent this flow characteristic deviation, therefore, the ECU 10 is configured to execute the following EGR controls and others.

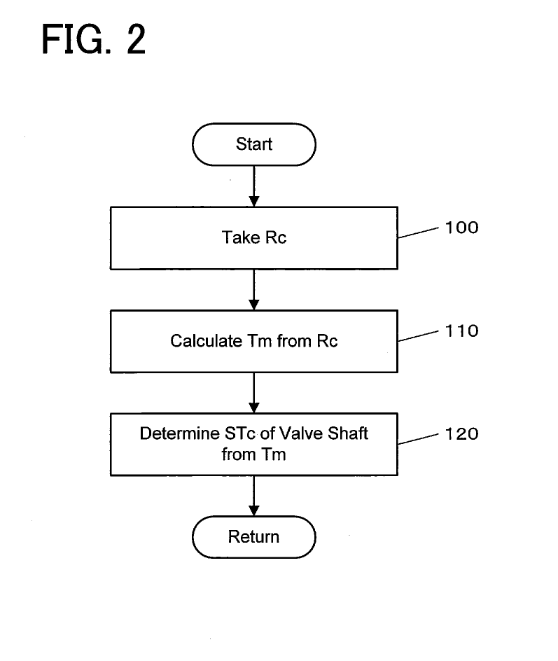

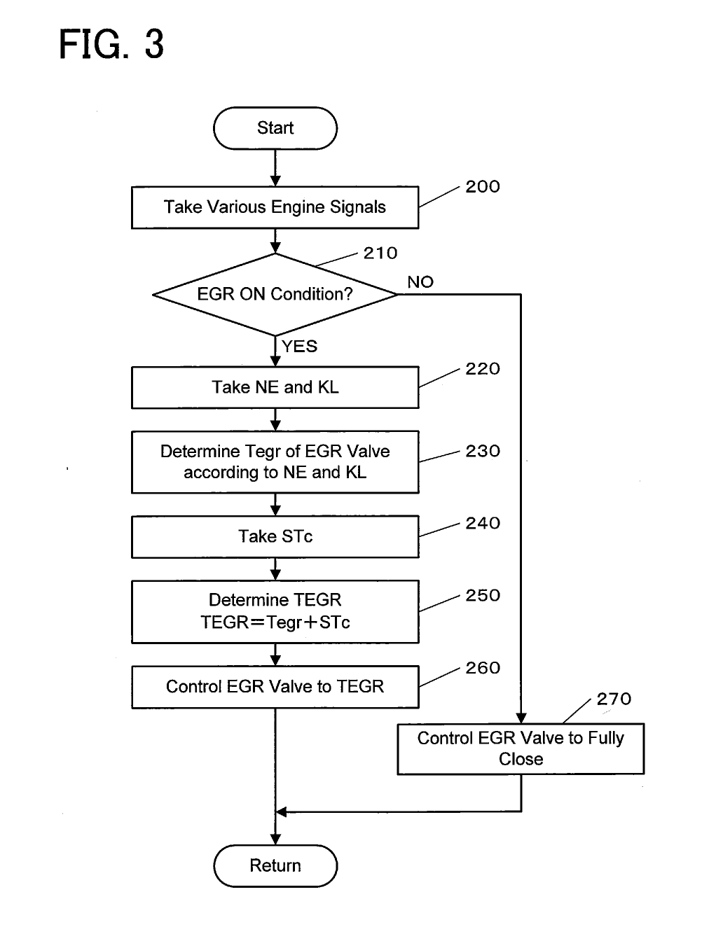

FIG. 2 is a flowchart showing one example of a temperature compensation processing to be executed by the ECU 10. FIG. 3 is a flowchart showing one example of processing details of EGR control to be executed by the ECU 10.

During operation of the engine, when the processing proceeds to a routine shown in FIG. 2, the ECU 10 takes, or reads, a resistance value Rc of the coils 11 (“coil resistance value”) in Step 100. Specifically, the ECU 10 detects the coil resistance value Rc as information associated with a motor temperature Tm by utilizing the coils 11 of the motor 4 as a temperature sensor to detect the temperature (motor temperature) Tm of the whole motor 4.

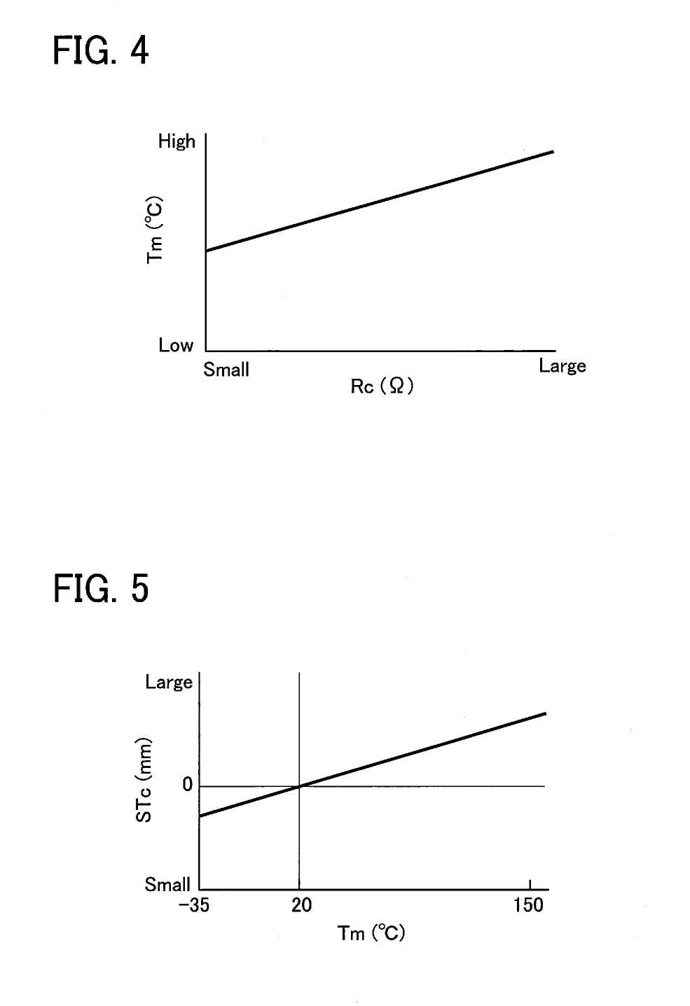

In Step 110, the ECU 10 then calculates the motor temperature Tm from the coil resistance value Rc. The ECU 10 can calculate this motor temperature Tm according to the coil resistance value Rc by referring to a map shown in FIG. 4. In the map shown in FIG. 4, the motor temperature Tm is set to be higher as the coil resistance value Re is larger.

In Step 120, successively, the ECU 10 determines a stroke compensation amount STc of the valve shaft 8 from the motor temperature Tm. This stroke compensation amount STc is a value to compensate a stroke deviation of the valve shaft 8 due to temperature change. For instance, the ECU 10 can calculate the stroke compensation amount STc corresponding to the motor temperature Tm by referring to a map shown in FIG. 5. In the map shown in FIG. 5, the stroke compensation amount STc is set to be larger as the motor temperature Tm is higher.

On the other hand, during operation of the engine, when the processing proceeds to a routine shown in FIG. 3, the ECU 10 takes various engine signals in Step 200. Specifically, the ECU 10 takes various engine signals as engine operation information from detection values of various sensors provided in the engine.

In Step 210, successively, the ECU 10 determines whether or not an EGR ON condition is established. Specifically, the ECU 10 judges whether or not the current operating condition of the engine is a condition enabling execution of EGR. If a negative determination (NO) is made in Step 210, the ECU 10 controls the EGR valve 1 to fully close in Step 270 and then returns the processing to Step 200. If a positive determination (YES) is made in Step 210, the ECU 10 shifts the processing to Step 220.

In Step 220, the ECU 10 takes an engine rotation speed NE and an engine load KL.

In Step 230, the ECU 10 determines a target opening degree Tegr according to the engine rotation speed NE and the engine load KL. The ECU 10 can determine this target opening degree Tegr by referring to a predetermined map.

In Step 240, the ECU 10 takes the stroke compensation amount STc determined in the routine of FIG. 2.

In Step 250, subsequently, the ECU 10 determines a final target opening degree TEGR. The ECU 10 calculates this final target opening degree TEGR by adding the stroke compensation amount STc to the target opening degree Tegr.

In Step 260, the ECU 10 controls the EGR valve 1 to open at the final target opening degree TEGR. Specifically, the ECU 10 controls the operation of the motor 4 based on the final target opening degree TEGR. Thereafter, the ECU 10 returns the processing to Step 200.

According to the above control, the ECU 10 calculates the target opening degree Tegr of the EGR valve 1, uses the coils 11 as a temperature sensor to detect the temperature (motor temperature) Tm of the motor 4, compensates the target opening degree Tegr based on the detected motor temperature Tm to find the final target opening degree TEGR, and controls the motor 4 based on the final target opening degree TEGR which is a compensated target opening degree. Herein, the ECU 10 detects the coil resistance value Rc and also calculates the motor temperature Tm from the detected coil resistance value Rc, determines the stroke compensation amount STc of the valve shaft 8 reflecting the linear expansion difference between the valve housing 3 and the motor housing 5 from the calculated motor temperature Tm, and compensates the target opening degree Tegr by the determined stroke compensation amount STc.

According to the control device for the exhaust gas recirculation valve in the present embodiment explained as above, the target opening degree Tegr is compensated based on the motor temperature Tm, thereby removing the deviation of the EGR gas flow rate characteristics deriving from the linear expansion difference between the valve housing 3 and the motor housing 5 made of different materials. This can adjust the EGR gas flow rate with good controllability as compared with conventional control of the EGR valve. Since the coils 11 of the motor 4 are used as the temperature sensor, there is no need to additionally provide a dedicated temperature sensor to detect the temperature of the motor housing 5. Accordingly, it is possible to prevent a deviation of flow characteristics of the EGR valve 1 due to temperature change without additionally providing a dedicated temperature sensor. This can suppress an increase in the number of components and the size of the EGR valve 1, thereby avoiding cost increase of the EGR apparatus.

In the present embodiment, the coil resistance value Rc is decided by reflecting both the self-hating of the motor 4 and the heat the motor 4 receives from outside. It is thus possible to obtain the temperature reflecting the temperature of the whole motor 4 from the coil resistance value Rc. Consequently, the temperature of the whole motor 4 is reflected well and the flow characteristics of the EGR valve 1 can be prevented from deviating. In this regard, the EGR gas flow rate can also be adjusted with good controllability as compared with the conventional control of the EGR valve.

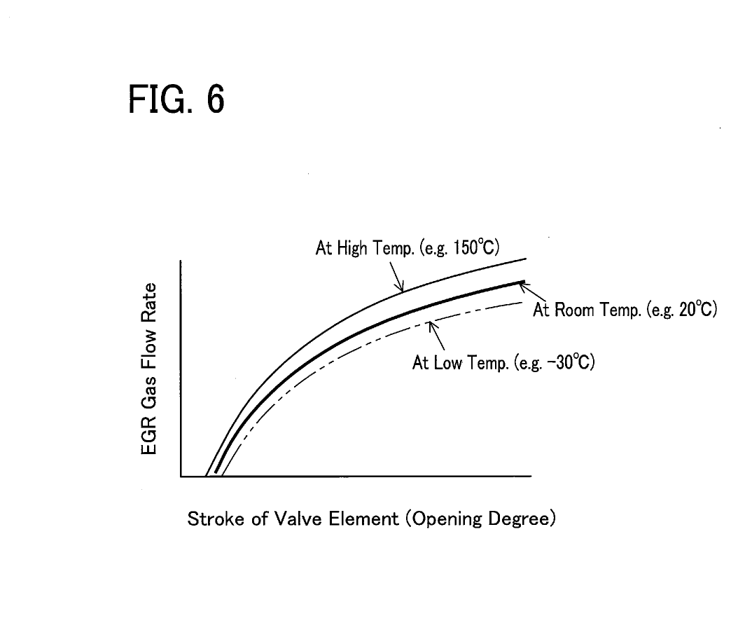

FIG. 6 is a graph showing a relationship between the stroke (opening degree) of the valve element 7 and the EGR gas flow rate. As clearly seen from this graph, the EGR gas flow rate varies according to differences in motor temperature Tm. Specifically, with reference to the EGR gas flow rate at a room temperature (e.g., 20° C.) as indicated by a thick line in FIG. 6, the EGR gas flow rate at a high temperature (e.g., 150° C.) deviates to an increase side than the reference as indicated by a broken line in FIG. 6 and the EGR gas flow rate at a low temperature (e.g., −30° C.) deviates to a decrease side than the reference as indicated by a chain double-dashed line in FIG. 6. According to the control device in the present embodiment, both the EGR gas flow rates at the high temperature and the low temperature can be compensated to the EGR gas flow rate at the room temperature.

The present invention is not limited to the aforementioned embodiment and the invention may be embodied in other specific forms without departing from the essential characteristics thereof.

In the above embodiment, the valve housing 3 is made of metal and the motor housing 5 is made of resin. As alternative, the valve housing and the motor housing may be made of any materials as long as they are made of different kinds of materials, not limited to a combination of metal and resin.

### INDUSTRIAL APPLICABILITY

The present invention is utilizable for example to an EGR apparatus of an engine of a car.

### REFERENCE SIGNS LIST

1 EGR valve
2 Gas passage
3 Valve housing
4 Motor
5 Motor housing
6 Valve seat
6a Valve hole
7 Valve element
8 Valve shaft
10 ECU
11 Coil
12 Stator
13 Output shaft
14 Rotor
Rc Coil resistance value
Tm Motor temperature
STc Stroke compensation amount

1. A control device for an exhaust gas recirculation valve,
wherein the exhaust gas recirculation valve includes a valve housing having a gas passage and a motor housing containing a motor, the valve housing and the motor housing being made of different kinds of materials,
the valve housing is provided with a valve seat, a valve element placed to be movable into or out of contact with the valve seat, and a valve shaft for moving the valve element with respect to the valve seat,
the motor includes: a stator having a coil; and a rotor having an output shaft,
the motor being configured to rotate the rotor together with the output shaft to make stroke movement of the valve shaft in an axial direction to change an opening degree of the valve element with respect to the valve seat,
the control device includes a control unit to control the exhaust gas recirculation valve, and
the control unit is configured to determine a target opening degree of the exhaust gas recirculation valve, use the coil as a temperature sensor for detecting a temperature of the motor, compensate the target opening degree based on the detected temperature, and control the motor based on the compensated target opening degree.

2. The control device for an exhaust gas recirculation valve according to claim 1, wherein the control unit is configured to detect a resistance value of the coil, calculate the temperature of the motor from the detected resistance value, determine a stroke compensation amount of the valve shaft reflecting a linear expansion difference between the valve housing and the motor housing from the calculated temperature, and compensate the target opening degree from the determined stroke compensation amount.
